(19) United States
(12) Patent Application Publication
(10) Pub. No.: US 2004/0239768 A1
(43) Pub. Date: Dec. 2, 2004

(54) Image pickup apparatus

(75) Inventor: Keiichiro Yanagida, Hamura-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/805,322

(22) Filed: Mar. 22, 2004

(30) Foreign Application Priority Data
May 30, 2003 (JP) 2003-154250

(51) Int. Cl. H04N 5/225

(52) U.S. Cl. 348/207.99

(57) ABSTRACT

An image pickup apparatus having an electric bulb base portion which receives a power source voltage, a socket portion which holds an electric bulb to be mounted, and which supplies the power source voltage received by the base portion, to the mounted electric bulb, an image pickup section which operates on the basis of the power source voltage, and which picks up incident light via an objective lens and outputs an image signal, and a transmission section which receives the image signal from the image pickup section and outputs the image signal to the exterior, and the image pickup apparatus can be easily installed in an electric bulb socket or the like of a ceiling or the like, and has all of the functions of illumination, image pickup., and communication.

### CROSS-REFERENCE TO RELATED APPLICATIONS

This application is based upon and claims the benefit of priority from prior Japanese Patent Application No. 2003-154250, filed May 30, 2003, the entire contents of which are incorporated herein by reference.

### BACKGROUND OF THE INVENTION

1. Field of the Invention

The present invention relates to an image pickup apparatus such as a network camera or the like, and in particular, to an image pickup apparatus which can be attached to an electric bulb socket which is a lighting fixture.

2. Description of the Related Art

Recently, accompanying the popularization of digital equipment, many types of image information equipment, such as digital cameras and the like as well have been developed and manufactured. In such a digital camera, attaching engineering work and power source engineering work are required, it is difficult to use the digital camera for a short time, or for an individual to easily use the digital camera. On the other hand, in the prior art (Jpn. UM. Appln. KOKAI Publication No. 4-105769), there is disclosed an example in which a television camera which can be easily attached to an electric bulb socket due to a base for an electric bulb being provided at a power source intake portion. In accordance therewith, power source wiring work or the like is not required, and a monitoring camera or the like can be easily installed.

However, in the above-described prior art, the monitoring camera is installed after the electric bulb is detached, and naturally, because illumination by an electric bulb cannot be carried out at the place where there is the socket, it is liable to be insufficient illuminance. Further, the wiring for supplying picked-up image information to, for example, a PC (Personal Computer) on a network is required to be separately provided, and there is the problem that it is the burden to the user.

### BRIEF SUMMARY OF THE INVENTION

According to an aspect of the invention, there is provided an image pickup apparatus comprising: an electric bulb base portion which receives a power source voltage; a socket portion which holds an electric bulb to be mounted, and which supplies the power source voltage received by the base-portion, to the mounted electric bulb; an image pickup section which operates on the basis of the power source voltage supplied via the base portion, and which picks up incident light via an objective lens and outputs an image signal; and a transmission section which operates on the basis of the power source voltage, and which receives the image signal from the image pickup section and transmits the image signal to the exterior.

### BRIEF DESCRIPTION OF THE SEVERAL VIEWS OF THE DRAWING

FIG. 1 is a schematic diagram showing an outline of an image pickup apparatus of a first embodiment according to the present invention.

FIG. 2 is a schematic diagram showing another outline of the image pickup apparatus of the first embodiment according to the present invention.

FIG. 3 is a schematic diagram showing an outline of an image pickup apparatus of a second embodiment according to the present invention.

FIG. 4 is a schematic diagram showing an operation of the image pickup apparatus of the second embodiment according to the present invention.

FIG. 5 is a schematic diagram showing an outline of an image pickup apparatus of a third embodiment according to the present invention.

FIG. 6 is a schematic diagram showing an outline of an image pickup apparatus of a fourth embodiment according to the present invention.

FIG. 7 is a block diagram showing one embodiment of a configuration of the image pickup apparatus according to the present invention.

FIG. 8 is an explanatory diagram showing an example of a method for connecting the image pickup apparatus according to the present invention and a network.

FIG. 9 is a cross-sectional view showing one embodiment of a configuration of an image pickup unit according to the present invention.

### DETAILED DESCRIPTION OF THE INVENTION

Hereinafter, a network camera which is an image pickup apparatus according to the present invention will be described in detail with reference to the drawings.

<Common Configuration of the Image Pickup Apparatus According to the Present Invention>

First, common configurations and functions in the respective embodiments of the image pickup apparatus according to the present invention will be described in detail with reference to the drawings.

(Configuration)

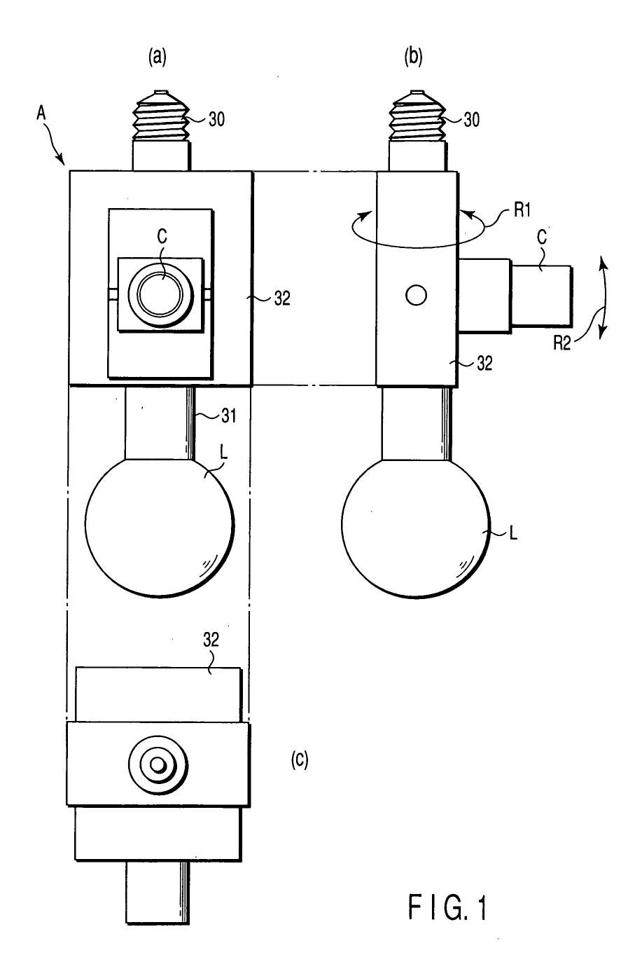

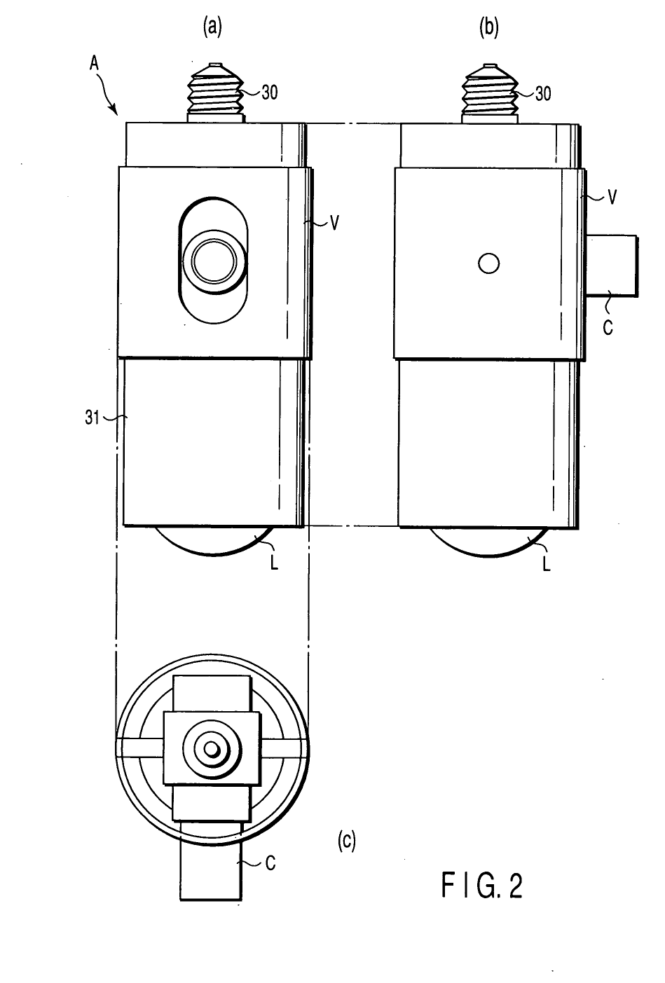

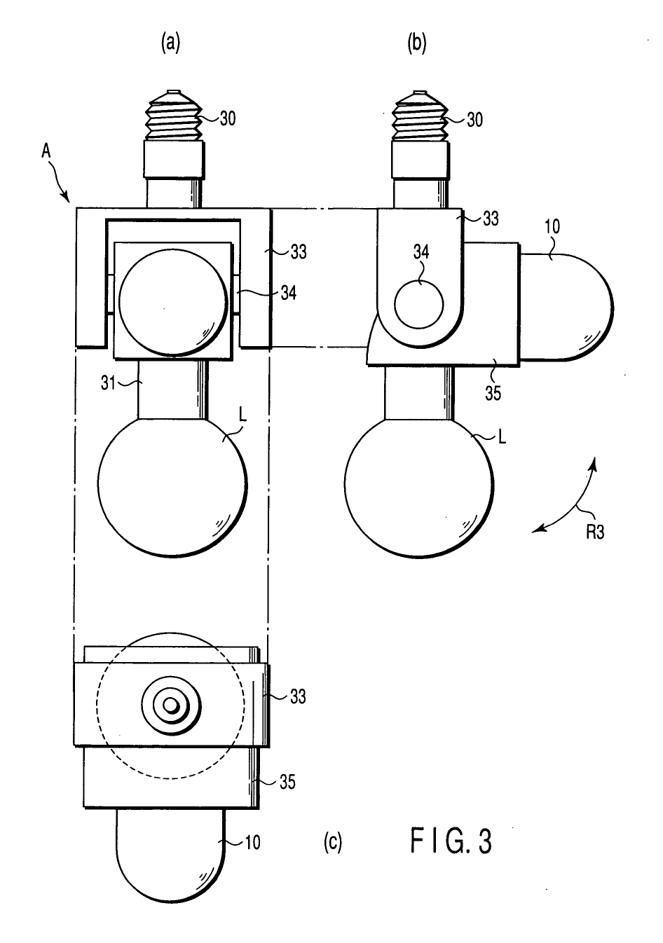

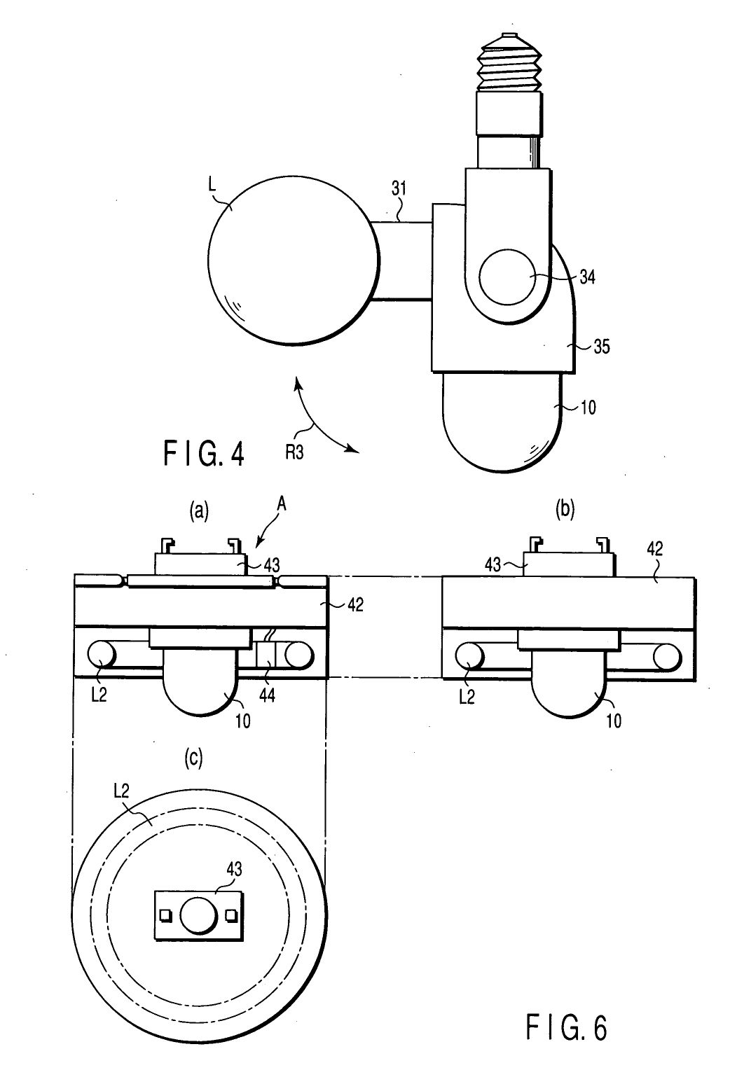

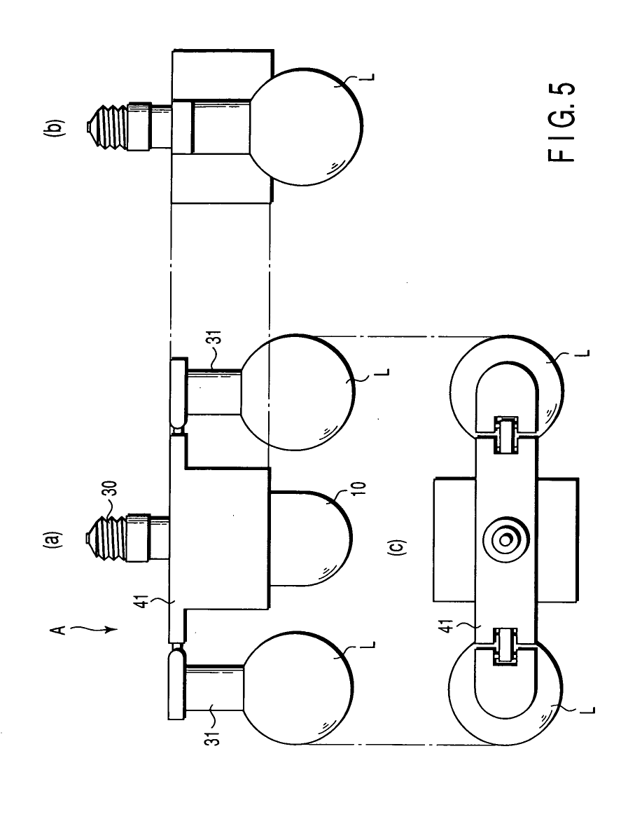

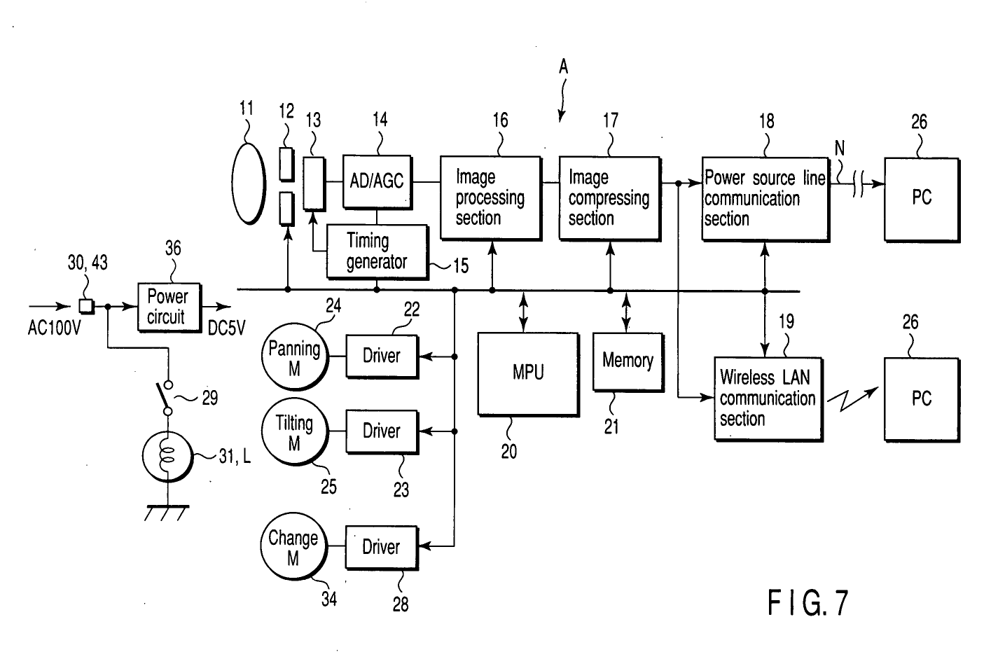

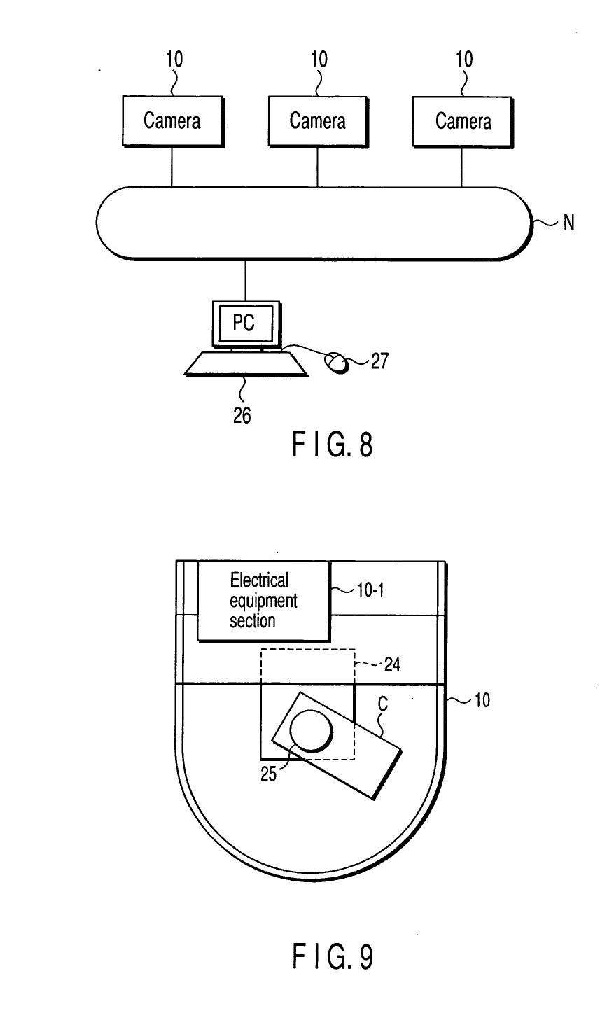

The image pickup apparatus and an image pickup system according to the present invention will be described hereinafter by using the drawings, and by using the case of a PC (Personal Computer) connected to a network camera and a network as an example. FIG. 1 is a schematic diagram showing an outline of an image pickup apparatus of a first embodiment according to the present invention, FIG. 2 is a schematic diagram showing another outline, FIG. 3 is a schematic diagram showing an outline of an image pickup apparatus of a second embodiment according to the present invention, FIG. 4 is a schematic diagram showing the operation thereof, FIG. 5 is a schematic diagram showing an outline of an image pickup apparatus of a third embodiment according to the present invention, FIG. 6 is a schematic diagram showing an outline of an image pickup apparatus of a fourth embodiment according to the present invention, FIG. 7 is a block diagram showing one embodiment of a configuration of the image pickup apparatus according to the present invention, FIG. 8 is an explanatory diagram showing an example of a method for connecting the image pickup apparatus according to the present invention and a network, and FIG. 9 is a cross-sectional view showing the embodiment of a configuration of an image pickup unit according to the present invention.

As shown in FIG. 1 to FIG. 7, an image pickup apparatus A according to the present invention is an image pickup apparatus which can be easily installed in an unillustrated electric bulb socket or in a ceiling terminal hub for a ceiling lighting fixture which is provided at a ceiling of a room or the like, by having at least a base portion 30 for an electric bulb or a ceiling terminal 43. Here, as shown in FIG. 7, an AC voltage of 100V or the like supplied from the base portion 30 or the ceiling terminal 43 is converted into a DC voltage of, for example, 5V or the like by a power circuit 36, and is used as a power source voltage for electrical equipment for an image processing system, a communication processing system, and a control system.

Moreover, in the image pickup apparatus A according to the present invention, in addition to an image pickup function, an electric bulb socket portion 31 which receives a power source voltage from the electric bulb base portion 30 or the ceiling terminal 43, and a connecting terminal portion 44 for being connected to a lamp L2 are provided. The image pickup apparatus A is an image pickup apparatus having an illumination function as well due to a lamp L and the lamp L2 being connected thereto.

Next, the function as an image pickup apparatus will be mainly described hereinafter. As shown in FIG. 7, the image pickup apparatus A according to the present invention has an objective lens 11, a mechanical iris mechanism 12 which receives incident light which passes through the objective lens 11, and which receives a control signal corresponding to a predetermined exposure value and carries out mechanical exposure adjustment in accordance with the control signal, and a solid image pickup element 13 formed from a CCD (Charge Coupled Device) which receives the incident light which is exposure-adjusted and outputs a detection signal corresponding to the exposure-adjusted incident light, or the like. Moreover, the solid image pickup element 13 receives a control signal for controlling timing of the converting processing when a detection signal is converted in accordance with the incident light from a timing generator 15, and carries out the converting processing, and exposure adjustment is possible by corresponding to the timing provided by the control signal. Moreover, the detection signal from the solid image pickup element 13 is supplied to an analog-to-digital converter/AGC (Auto Gain Controller) 14, and is converted into a digital signal, and the digital signal is further converted into an appropriate value in accordance with the control signal from the timing generator 15, and is output.

Moreover, the image pickup apparatus A has an image processing section 16 receiving the output from the analog-to-digital converter/AGC circuit 14, and an image compressing section 17 carrying out compression processings such as MPEG compression, JPEG compression, or the like, with respect to an image signal which is processed at the image processing section 16. At the image processing section 16, image processings such as, for example, sharpness processing, contrast processing, gamma correction, white balance processing, pixel addition processing, or the like, are carried out on the input image signal.

Moreover, the image pickup apparatus A has an MPU (Main Processing Unit) 20 which controls the entire processing operations, and which controls an exposure photometric region setting processing which is the feature of the present invention and which will be described later, and a memory 21 in which a program managing these operations is stored, and which provides a work area for carrying out the respective processing operations on the image signal, and in which image data for alarm indication indicated at the time of movement detection or the like, and the like are stored.

Further, the image pickup apparatus A has a power source line Ethernet communication section 18 and a wireless LAN (Local Area Network) communication section 19 which are connected to the MPU 20 via a data bus, and carries out communication processing with, for example, an external PC 26 via a wire network N or a wireless network. Note that the power source line Ethernet communication section 18 carries out communication with an external device via a power source line with respect to a control signal and an image pickup signal at a high-frequency region which is not affected by the power source voltage. Furthermore, it is preferable to use infrared-ray communication as a communication function.

Moreover, the image pickup apparatus A has a panning driver 22 for driving a camera unit C in the panning direction, a panning motor 24 such as a stepping motor or the like, a tilting driver 23 for driving the camera unit C in the tilting direction, and a tilting motor 25 such as a stepping motor or the like, which are connected to the MPU 20 via the data bus and are controlled by the MPU 20. Here, the camera unit has at least the objective lens C, the mechanical iris 12, and the solid image pickup element 13 described above.

Further, as shown in FIG. 8, a plurality of the image pickup apparatuses A can be provided via the network N. Moreover, driving processings, in the panning direction and the tilting direction, of the image pickup apparatuses A are possible by the PC 26 or the like, and furthermore, monitoring and recording/playback processing of the image signal which is picked up by the image pickup apparatus A are possible. Further, a pointing device such as a mouse or the like is connected to the PC 26, and in particular, the PC 26 can easily carry out the exposure photometric range setting which will be described later.

Moreover, as shown in FIG. 9, the image pickup apparatus A has the camera unit C, the panning motor 24 for driving the camera unit C in the panning direction, and the tilting motor 25 for driving the camera unit C in the tilting direction, and further has an electrical equipment section 10-1 having a configuration other than those shown in FIG. 7. Furthermore, in a second embodiment which will be described later and is shown in FIG. 3 and FIG. 4, a change motor 34 for changing the positions of the lamp L and the image pickup section 10, and a driver 28 thereof as well are provided.

(Basic Operations)

The image pickup apparatus A having such a configuration carries out basic operations as described hereinafter. Namely, the image pickup apparatus A can carry out the image pickup operation in which incident light from an object is received and an image signal corresponding to the image picked-up screen is supplied via a network or the like, and camera driving operation in which a direction of the camera unit C is driven, for example, in the panning direction and the tilting direction, and further, the respective operation modes (for example, a movement detecting operation) based on the picked-up image signal, various types of setting operations such as setting of an exposure photometric range which will be described later, and the like, the self-testing operation, or the like.

Moreover, because the image pickup apparatus A has the socket portion 31 and the connecting terminal 44, as well, which receives a power source voltage from the electric bulb base portion 30 or the ceiling terminal 43, the image pickup apparatus A has the function as a normal lighting fixture due to the lamps L and L2 being connected thereto.

Namely, the image pickup operation is carried out by the control of the MPU 20 in accordance with an operation program stored in the memory 21, due to an instruction signal being received from the PC 26 which is a control device, or the like, via the network N (or the wireless network). The solid image pickup element 13 which received the incident light from the object via the objective lens 11 supplies a detection signal corresponding to the incident light to the analog-to-digital converter circuit/AGC circuit 14.

Here, as an example, the exposure adjustments are respectively carried out by the controls of the mechanical iris mechanism 12, the solid image pickup element 13, and the AGC circuit 14. Namely, the mechanical iris mechanism 12 receives an exposure control signal from the MPU 20, and carries out a desired exposure adjustment by controlling quantity of light which is taken therein. Further, the solid image pickup element 13 receives an exposure control signal from the MPU 20 in the same way, and carries out an exposure adjustment due to a timing signal being supplied from the timing generator 15 in accordance therewith, and by carrying out converting processing of the incident light into a detection signal in accordance with that timing. Further, the AGC circuit 14 carries out exposure adjustment due to a control signal being supplied from the timing generator 15 which received the exposure control signal from the MPU 20 in the same way, and by controlling the gain of the detection signal supplied from the solid image pickup element 13 in accordance therewith. Further, here, as an example, the exposure adjustments at three stages are shown. However, it is possible to carry out an exposure adjustment by one of those.

Further, in the camera driving operation, after zero coordinate adjustment is carried out due to the panning motor 24 and the tilting motor 25 which are the stepping motors, the MPU 20 always recognizes the current direction of the camera unit C. In accordance therewith, the MPU 20 always manages the coordinate of the screen which the camera unit C has currently picked up, and at the same time when the image picked-up screen is changed due to the camera unit C being driven in the panning direction or the tilting direction in accordance with an operation control signal supplied from the MPU 20 to a driver, the MPU 20 always recognizes the coordinate of the current image picked-up screen. Accordingly, while watching, from the screen of the PC 26 or the like connected via the network, the image picked-up screen which corresponds to the image signal which the image pickup apparatus A is currently continuing to supply, the user can move the camera unit C in the panning direction or the tilting direction, and can watch an image picked-up screen which corresponds to the movement. Further, the MPU 20 recognizes and manages the coordinates of the current image picked-up screen, and the user can acquire the coordinate information of the current image picked-up screen, for example, on the PC 26, in accordance with the operation.

Further, in the respective operation modes, for example, in the movement detecting operation mode, the image pickup apparatus A automatically detects a movement of an image within an arbitrary region set by the user. Namely, an observation region of the movement detection in the image picked-up screen is set in accordance with the operation by the user on the setting screen of the movement detecting operation mode, and thereafter, when variation greater than or equal to a predetermined value of the image picked-up screen is detected at the observation region during a set period, the MPU 20 determines that there is movement detection, and carries out, for example, a warning operation, i.e., an operation such as outputting an alarm signal, adding an alarm screen stored in the memory 21 to the image signal and outputting it, or the like.

(First Embodiment)

A first embodiment is an image pickup apparatus which receives a power source from an electric bulb base portion, and in which an image pickup section is provided without working with an electric bulb socket. Hereinafter, the first embodiment will be described in detail with reference to FIG. 1 and FIG. 2.

In the image pickup apparatus A according to the present invention, the electric bulb base portion 30 is provided as a power source input portion, and is connected to a housing section 32. Moreover, due to a rotation of the panning motor 24 which is not shown in FIG. 1, the entire housing accompanying the socket 31 rotates in the direction R1 with respect to the base portion 30. Furthermore, the camera unit C moves in the direction R2 by the tilting motor 25 which is not shown in FIG. 1, and in accordance therewith, the camera unit C can obtain an image of an entire room.

Further, as shown in FIG. 1, due to the socket portion 31 being provided, and the electric bulb L being mounted, the illumination function and the image pickup function can be provided together. Furthermore, in FIG. 2, covers V are provided at the image pickup apparatus A shown in FIG. 1, and in accordance therewith, due to a dustproof function being provided, the operational reliability can be further improved.

(Second Embodiment)

A second embodiment is an image pickup apparatus which receives a power source from an electric bulb base portion, and in which a movement of the position of the image pickup section can be carried out by working with an electric bulb socket. Hereinafter, the second embodiment will be described in detail with reference to FIG. 3 and FIG. 4.

At the image pickup apparatus A according to the present invention, the electric bulb base portion 30 is provided as a power source input portion, and is connected to a housing section 33. Moreover, a unit 35 is provided and the electric bulb socket 31 for the electric bulb L and the image pickup section 10 are fixed to the unit 30 at, as one example, an angle of 90°.

Here, in the image pickup apparatus A of the second embodiment, due to the operations of the driver 28 and the change motor 34, the electric bulb L can be disposed at the right under position which is the optimum position, and the image pickup section 10 can be disposed at the right under position which is the optimum position. In FIG. 4, a state in which the image pickup section 10, in place of the electric bulb L and the electric bulb socket 31, is disposed at the right under position which is the optimum position by a movement. In accordance therewith, the camera unit C can obtain an image of an entire room under the optimum conditions accompanying the operations of the panning motor 24 and the tilting motor 25 described above.

Further, the operation of the unit 35 can be operated from a screen of the PC 26 on the network by the power source line communication section 18, the wireless LAN 19, an unillustrated infrared-ray communication function, or the like.

In this way, in the second embodiment, due to the unit 35 being appropriately operated, the electric bulb L is disposed at the optimum position, or the image pickup section 10 is disposed at the optimum position, and the illumination function and the image pickup function can be sufficiently made to perform in accordance with a situation.

(Third Embodiment)

A third embodiment is an image pickup apparatus which receives a power source from an electric bulb base portion, and at which a plurality of electric bulb sockets are provided. The third embodiment will be described in detail with reference to FIG. 5.

In the third embodiment, as shown in FIG. 5, in the image pickup apparatus A according to the present invention, the image pickup section 10 is provided at a position opposite to the base portion 30 with respect to the housing of the image pickup apparatus A from the first. When the image pickup apparatus A is attached due to the base portion 30 being screwed into the socket provided at the ceiling, because the image pickup section 10 can image-pickup the room from the ceiling toward the right under direction, the optimum position for image pickup can be provided. Further, because the electric bulbs 31 for the electric bulbs L are provided at right and left at even intervals, it has a configuration having a stable center of gravity. It is preferable as well that three of the electric bulbs 31 are provided, for example, at every 120°. Moreover, it is preferable in the same way that four of the electric bulbs 31 are provided at every 90°, or the like, and due to a plurality of lamps being provided, the structural stability can be obtained.

(Fourth Embodiment)

A fourth embodiment is an image pickup apparatus which receives a power source from a ceiling terminal of a ceiling lighting fixture, and in which the image pickup section is further provided at a position right under the ceiling terminal. The fourth embodiment will be described in detail with reference to FIG. 6.

In the fourth embodiment, as shown in FIG. 6, with respect to the image pickup apparatus A according to the present invention, when the image pickup apparatus A is attached due to the ceiling terminal of the image pickup section 10 being fitted into the ceiling terminal hub provided at the ceiling with respect to the housing of the image pickup apparatus A, the image pickup section 10 is disposed at a position where the room can be picked up from the ceiling toward the right under direction.

In accordance therewith, in the same way, the camera unit C of the image pickup section 10 can obtain an image of the entire room under the optimum conditions accompanying the operations of the panning motor 24 and the tilting motor 25 described above.

In addition, because the connecting terminal 44 is provided in order to provide the doughnut-shaped lamp L2, the illumination function can be sufficiently made to perform.

As described above, the image pickup apparatus according to the present invention can not only be easily installed in the electric bulb socket provided at a ceiling or the like due to the electric bulb base portion which receives a power source voltage, but also has the electric bulb socket for supplying the power source voltage in addition to the image pickup section. In accordance therewith, because the electric bulb is installed to the electric bulb socket, and illumination can be carried out, the image pickup apparatus in which an attempt can be made to have both of illumination and photographing can be provided.

Namely, in accordance with the present invention as described above, the image pickup apparatus which can be easily installed at a place provided for installing a lighting fixture, and which can have all of the illumination function, the image pickup function, and the communication function, can be provided.

In accordance with the various embodiments described above, the skilled in the art can realize the present invention. However, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

What is claimed is:

1. An image pickup apparatus comprising:
an electric bulb base portion which receives a power source voltage;
a socket portion which holds an electric bulb to be mounted, and which supplies the power source voltage received by the base portion, to the mounted electric bulb;
an image pickup section which operates on the basis of the power source voltage supplied via the base portion, and which picks up incident light via an objective lens and outputs an image signal; and
a transmission section which operates on the basis of the power source voltage, and which receives the image signal from the image pickup section and outputs the image signal to the exterior.

2. The image pickup apparatus according to claim 1, further comprising:
the image pickup section and the transmission section vertically under the base portion; and
a housing for disposing the socket portion under the image pickup section and the transmission section.

3. The image pickup apparatus according to claim 1, further comprising a power circuit which converts the power source voltage which is an AC power source supplied from the base portion, into a DC power source, and which supplies the DC power source to the image pickup section and the transmission section.

4. The image pickup apparatus according to claim 1, wherein the transmission section transmits at least the image signal to the exterior by a wireless LAN.

5. The image pickup apparatus according to claim 1, wherein the transmission section transmits at least the image signal to the exterior by a LAN via a power source line.

6. The image pickup apparatus according to claim 1, wherein the socket portion and the image pickup section are installed in a common unit, and due to the unit being driven with respect to the housing of the image pickup apparatus, one of the socket portion and the image pickup section is vertically disposed at the lowest position.

7. The image pickup apparatus according to claim 6, wherein the socket portion and the image pickup section are installed in the unit such that the installing directions thereof are different from one another by 90°, and due to an angle of the unit with respect to the housing being changed, one of the socket portion and the image pickup section is made to direct right below.

8. The image pickup apparatus according to claim 1, wherein the image pickup section has a camera unit having the objective lens and a solid image pickup element, and respectively has a panning motor driving the camera unit in the panning direction and a tilting motor driving the camera unit in the tilting direction.

9. The image pickup apparatus according to claim 1, wherein the image pickup section is provided at a position opposite to the base portion with respect to the housing of the image pickup apparatus, and when the image pickup apparatus is attached to a socket provided at the ceiling due to the base portion being screwed into the socket, the image pickup section can image-pickup the room from the ceiling toward the right under direction.

10. The image pickup apparatus according to claim 9, wherein a plurality of the socket portions are disposed at positions horizontal with the image pickup section.

11. An image pickup apparatus comprising:
a ceiling terminal which receives a power source voltage;
a connecting terminal portion which is connected to a lamp and which supplies the power source voltage received from the ceiling terminal, to the lamp;
an image pickup section which operates on the basis of the power source voltage supplied via the ceiling terminal, and which picks up incident light via an objective lens and outputs an image signal; and
a transmission section which operates on the basis of the power source voltage, and which receives the image signal from the image pickup section and outputs the image signal to the exterior.

12. The image pickup apparatus according to claim 11, wherein a doughnut-shaped lamp is connected to the connecting terminal, and the power source voltage is supplied thereto.

13. The image pickup apparatus according to claim 11, further comprising a power circuit which converts the power source voltage which is an AC power source supplied from the base portion, into a DC power source, and which supplies the DC power source to the image pickup section and the transmission section.

14. The image pickup apparatus according to claim 11, wherein the transmission section transmits at least the image signal to the exterior by a wireless LAN.

15. The image pickup apparatus according to claim 11, wherein the image pickup section is provided at a position opposite to the ceiling terminal with respect to the housing of the image pickup apparatus.
